(19) United States
(12) Patent Application Publication
(10) Pub. No.: US 2009/0049186 A1
(43) Pub. Date: Feb. 19, 2009

(54) METHOD TO FACILITATE TRICK-MODES FOR STREAMING VIDEO

(75) Inventors: Davender Agnihotri, Murrieta, CA (US); Brant Candelore, San Diego, CA (US)

Correspondence Address: FITCH EVEN TABIN & FLANNERY, 120 SOUTH LASALLE SUITE 1600, CHICAGO, IL, 60603, US

(73) Assignees: SONY CORPORATION, A JAPANESE CORPORATION, Tokyo (JP); SONY ELECTRONICS INC., A DELAWARE CORPORATION, Park Ridge, NJ (US)

(21) Appl. No.: 12/047,282

(22) Filed: Mar. 12, 2008

Related U.S. Application Data
(60) Provisional application No. 60/965,240, filed on Aug. 16, 2007.

(51) Int. Cl. G06F 15/16

(52) U.S. Cl. 709/231

(57) ABSTRACT

A method for navigating multimedia content comprising receiving an index list comprising a plurality of index points corresponding to timing information of portions of multimedia content, wherein the index list facilitates navigation through the multimedia content, selecting one of the plurality of index points from the index list, transmitting a request, after selecting one of the plurality of index points, to a service provider for one of the portions of multimedia content, wherein the request comprises the corresponding one of the plurality of index points, and receiving one of the portions of multimedia content corresponding to the request.

This application claims the benefit of U.S. Provisional Application No. 60/965,240, filed Aug. 16, 2007, which is incorporated in its entirety herein by reference.

### BACKGROUND OF THE INVENTION

1. Field of the Invention

The present invention relates generally to streaming multimedia content, and more specifically to facilitating trick modes streamed multimedia content.

2. Discussion of the Related Art

Video on demand (VOD) systems allow a viewer to buy or select a movie or television program which then begins to play on the viewer's television almost instantaneously. Multimedia content may either be streamed or downloaded from a network, allowing a viewer to either view the multimedia content in real time or view the multimedia content at the completion of the download. In the past, VOD systems were implemented on television set-top-box systems, however, VOD may be utilized on devices such as computers, mobile phones, and other systems configured to receive multimedia content over a network.

“Trick modes” for VOD systems allows VCR functionality such as pause, forward slow motion, backward slow motion, fast forward, and rewind to be utilized by the viewer. Multiple content files utilized to enable trick modes would typically consist of 1× content (normal playback) consisting of I-B-P-frames ordered in a forward or backward format. For example, for a 1× reverse, I-B-P-frames of the content are ordered in the reverse format (for backward motion) and placed in a file. For a 4× reverse, every fourth I-frame is placed in reverse format in a separate file. For a 10× reverse, every tenth I-frame is placed in a file. B-P-frames are mainly needed for smooth slow forward and backward motion in addition to I-frames. For faster forward or backward motion, only I-frames may be used. If slow motion is not supported, then the pointers may only be to I-frames.

Trick modes could also be implemented with streamed multimedia content by first downloading the content to the local storage of the receiving device. This allows retrieval of multimedia content and their corresponding I-B-P-frames to perform a slow motion scroll or jump forward or backwards through the multimedia content.

### SUMMARY OF THE INVENTION

Several embodiments of the invention provide a method for streaming multimedia content comprising pre-processing multimedia content, wherein the multimedia content comprises a plurality frames, creating an index list from the pre-processed multimedia content comprising a plurality of index points corresponding to timing information of portions of the multimedia content, wherein the index list facilitates navigation through the multimedia content, and transmitting the index list to a client device configured to view the multimedia content.

In another embodiment, the invention can be characterized as a method for navigating multimedia content comprising receiving an index list comprising a plurality of index points corresponding to timing information of portions of multimedia content, wherein the index list facilitates navigation through the multimedia content, selecting one of the plurality of index points from the index list, transmitting a request, after selecting one of the plurality of index points, to a service provider for one of the portions of multimedia content, wherein the request comprises the corresponding one of the plurality of index points, and receiving one of the portions of multimedia content corresponding to the request.

In a further embodiment, the invention may be characterized as a method for navigating content comprising, receiving multimedia content and a corresponding transfer rate and content size of the multimedia content, wherein the multimedia content comprises a plurality of frames, receiving a command to navigate to a portion of the multimedia content, determining an offset associated with the command, wherein the offset corresponds to the time difference between the current time position of the multimedia content and the time position of the portion of the multimedia content determined by at least one of the transfer rate, content size, and the portion of the multimedia content, transmitting a request for the portion of the multimedia content, wherein the request comprises the offset, and receiving the portion of the multimedia content.

In yet another embodiment, the invention may be characterized as a device for navigating content, comprising a communication unit configured to receive multimedia content and an index list comprising a plurality of index points corresponding to timing information of portions of the multimedia content, wherein the index list facilitates navigation through the multimedia content, a display unit coupled to the communication unit configured to display selections corresponding to the plurality of index points and the multimedia content, a user interface unit coupled to the display unit configured to receive user inputs corresponding to the selections, and a selection unit coupled to the display unit configured to select one of the plurality of index points associated with the user inputs.

In another embodiment, the invention may be characterized as a device for navigating content, comprising a communication unit configured to receive multimedia content and corresponding transfer rate and content size of the multimedia content, wherein the multimedia content comprises a plurality of frames, a display unit coupled to the communication unit configured to display the multimedia content, a user interface unit coupled to the display unit configured to receive commands associated with navigating to a portion of the multimedia content, and a determination unit coupled to the interface unit configured to determine an offset associated with the commands, wherein the offset corresponds to the time difference between the current time position of the multimedia content and the time position of the portion of the multimedia content determined by at least one of the transfer rate, content size, and the portion of the multimedia content.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a diagram of multimedia delivery system implementing an embodiment of the present invention.

FIG. 2 is a flow diagram of the steps taken by a service provider, such as may be employed in FIG. 1, to create an index list to facilitate trick modes.

FIG. 3 is a flow diagram of the steps taken by the service provider, such as may be employed In FIG. 1, to facilitate trick modes when streaming multimedia content.

FIG. 4 is a flow diagram of the steps taken by a client device, such as may be employed in FIG. 1, to utilize trick modes when viewing multimedia content.

FIG. 5 is an example of a conversation between devices in a multimedia delivery system, as may be employed in FIG. 1, to facilitate trick modes in accordance with an embodiment of the present invention.

FIG. 6 is a timing diagram between devices in a multimedia delivery system, as may be employed in FIG. 1, to facilitate trick modes in accordance with an embodiment of the present invention.

FIG. 7 is a structural block diagram of the client device, such as may be employed in FIG. 1, which utilizes trick modes in accordance with an embodiment of the present invention.

FIG. 8 is a flow diagram of the steps taken by the client device, such as may be employed in FIG. 1, to utilize trick modes when viewing multimedia content.

FIG. 9 is an example conversation between the client device and the service provider, as depicted in FIG. 1, to facilitate trick modes in accordance with another embodiment of the present invention.

FIG. 10 is a timing diagram between devices in a multimedia delivery system, as may be employed in FIG. 1, to facilitate trick modes in accordance with an embodiment of the present invention.

FIG. 11 is a structural block diagram of the client device, such as may be employed in FIG. 1, which utilizes trick modes in accordance with another embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

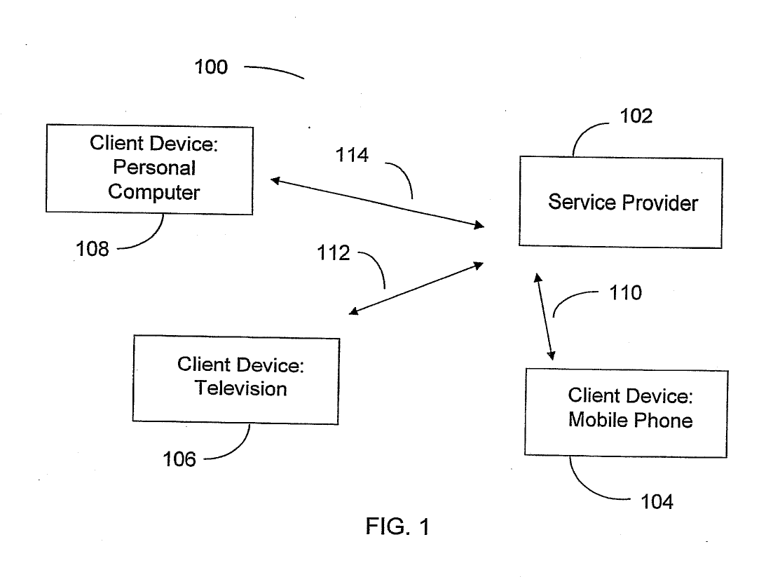

Referring first to FIG. 1, a multimedia delivery system 100 is shown comprising a service provider 102, various client devices 104-108, and communication links 110-114.

The multimedia delivery system 100 of FIG. 1 is shown comprising a service provider 102 which communicates to various client devices 104-108 through communication links 110-114. The service provider 102 communicates with a mobile phone 104 through communication link 110. In addition the service provider 102 communicates with a television 106 and a personal computer 108 through communication links 112 and 114, respectively.

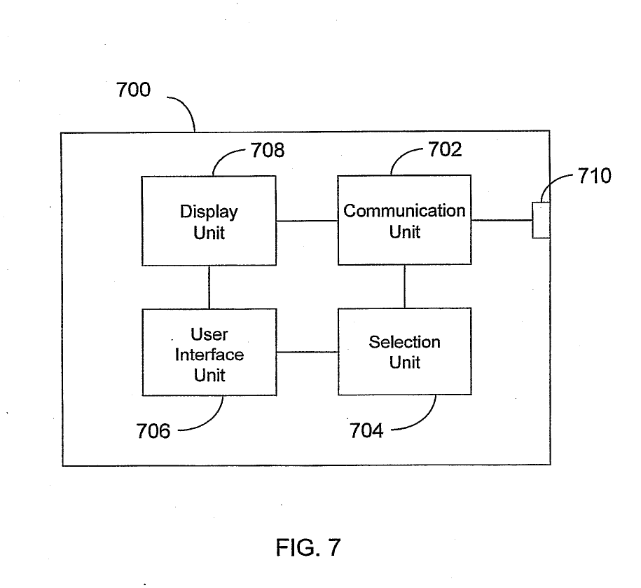

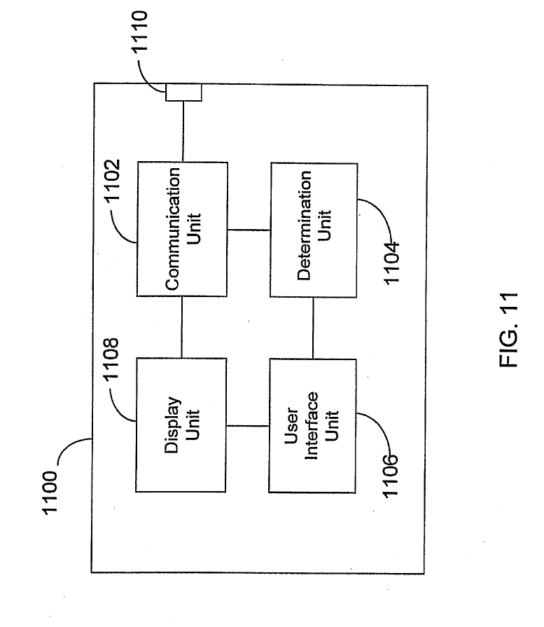

The service provider 102 transmits multimedia content and information for facilitating trick modes via the communication links 110-114 to the corresponding client device 104-108. The service providers 102 may include terrestrial broadcasters, satellite, phone, Internet and cable providers offering Video-on-Demand (VOD) capabilities which may stream multimedia content to a client device 104-108. However, it should be understood that the service provider 102 may be a hosting server, which provides multimedia content to various client devices, or other device capable of storing and transmitting multimedia content, such as television shows or movies, along with information to facilitate trick modes, such as fast forward or reverse, and communicating the multimedia content and further information through a network connection to a client device. One example could be a home PC acting as a service provider or hosting device connected over a local area network (LAN) to transmit streamed content to client devices, such as other PCs connected to the LAN. The communication links 110-114 may be a network connection, such as the internet or LAN. The communication links 110-114 allows the service provider 102 to supply streamed multimedia content to multiple client devices such as a mobile phone 104, television 106, and personal computer 108. However, it may be appreciated that the client devices 104-108 are not limited to a mobile phone 104, television 106, and personal computer 108 as depicted in FIG. 1, and may include other devices configured to receive and display multimedia content which allows a user to utilize “trick modes” such as fast or slow forward/reverse and pause. Further functionality of the client devices 104-108 will be discussed with respect to FIGS. 7 and 11.

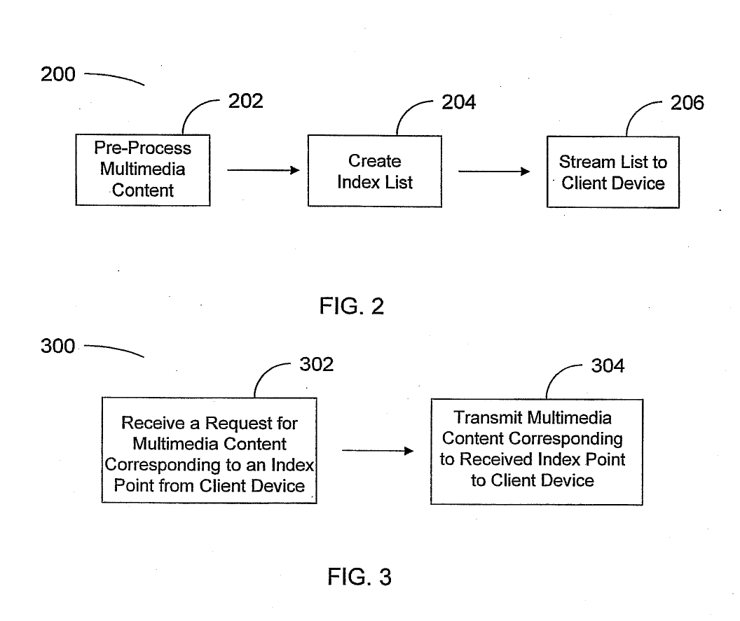

Referring next to FIG. 2, a flow diagram 200 of the steps taken by the service provider 102 to create an index list to facilitate trick modes in accordance with one embodiment of the present invention is illustrated comprising the steps of pre-processing multimedia content 202, creating an index list 204, and transmitting the index list to a client device 206.

The service provider 102 (FIG. 1) begins to create an index list to facilitate trick modes at step 202 by preprocessing multimedia content. Once multimedia content is preprocessed, the service provider 102 creates an index list corresponding to the multimedia content in step 204. After creating the index list in step 204, the service provider moves onto step 206 and streams the index list to the client device in step 206.

In accordance with one aspect of the present invention, the process to enable trick modes for streamed multimedia content is facilitated with the use of an index list created by the service provider 102. At step 202, the service provider 102 (or hosting server) pre-processes multimedia content file. The pre-processing includes determining timing information for the multimedia content. In one embodiment, the timing is represented as a byte offset from the beginning of the multimedia file. Timing information may comprise information such as the time locations of I-B-P-frames within the multimedia content, time codes, and chapter points associated with the time codes. At step 204, the service provider 102 creates an index list from the timing information gathered from the processed multimedia content. The index list comprises index points comprising timing information such as chapter points which correspond to portions of the multimedia content; these portions may include the I-B-P-frames of the multimedia content while the index points may be correlated to the time codes of the multimedia content or other timing information of the multimedia content. The information within the index list, such as the index points, is correlated to specific time locations within the multimedia content, such as the I-B-P-frames of the multimedia content which occurs at the specific time location. Therefore a request from a client device to return multimedia content at an index point would cause the service provider to return the multimedia content at the time location of the index point. In one embodiment, what the service provider returns to the client device includes the I-B-P-frame of the multimedia content at the time location of the index point.

At step 206, the service provider 102 streams the multimedia content along with the corresponding index list to the client device 104-108. As previously mentioned, the index list and multimedia content may be streamed by a VOD provider over the internet to client devices such as a home computer, television, or mobile phone. Alternatively, the index list and multimedia content may be streamed by a hosting device over a local area network to other receiving devices. In another embodiment of the present invention, the user may configure a hosting device, such as a personal computer, as the service provider to stream multimedia content and deliver the index list over the internet to a client device, such as a portable computer. This embodiment allows a user to stream and view multimedia content from their home devices regardless of the user's location. The client device 104-106 then utilizes the index list to enable trick modes for the streamed multimedia content.

The above embodiment of the present invention enables trick modes for streamed multimedia content by processing the multimedia content at the service provider 102, creating an index list of timing information, and transmitting the index list to the client device 104-108. Previous methods for enabling trick modes for streamed multimedia content required the download of the multimedia content prior to a user viewing the multimedia content on a client device 104-108. This method required large local storage and buffering capabilities on the part of the client device. Trick modes could also be implemented with streamed multimedia content by first downloading the content to the local storage of the receiving device. This allows retrieval of multimedia content and their corresponding I-B-P-frames to perform a slow motion scroll or jump forward or backwards through the multimedia content, however, the receiving device would need enough buffering capabilities to store the multimedia content and the receiving device can only perform trick play on the content that has actually being received. However, by processing the multimedia content and creating an index list, the present embodiment removes the need for large local storage and local buffering capabilities at the client device partly because trick modes may be enabled without downloading the multimedia content. In addition, alternate methods for enabling trick play at the service provider required additional files, e.g. ¼×, 4×, 10×, 30×, etc. In one embodiment, the client devices may access the single 1× file to accomplish trick modes.

Referring next to FIG. 3, a flow diagram 300 of the steps taken by the service provider 102, to facilitate trick modes when streaming multimedia content in accordance with one embodiment of the present invention is illustrated comprising the steps of receiving a request for multimedia content corresponding to an index point from the client device 302 and transmitting multimedia content corresponding to the received index point to the client device 304.

The service provider 102 (FIG. 1) begins the process of FIG. 3 at step 302, by receiving a request for multimedia content corresponding to an index point from the client device 104-108 (FIG. 1). Once the request is received 302, the service provider 102 then transmits multimedia content corresponding to the received index point to the client device 104-108 in step 304.

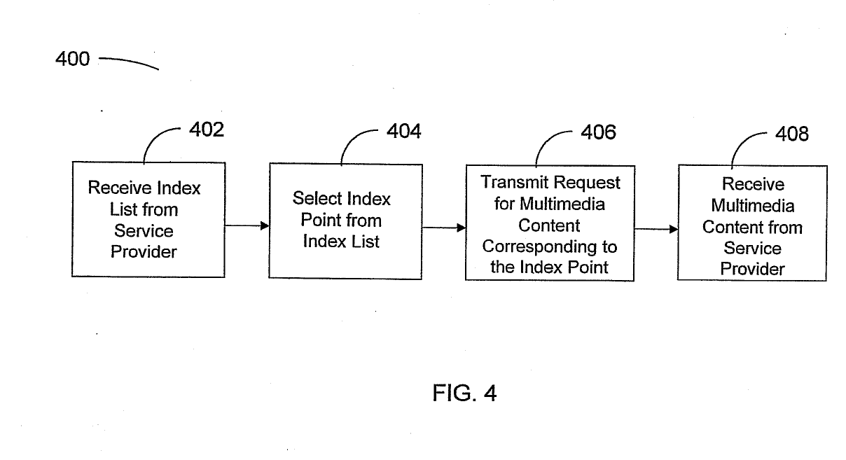

In accordance with one aspect of the present invention, the service provider 102 facilitates trick modes with the use of an index list of byte offsets in a multimedia file corresponding to the multimedia content and index points corresponding to timing information of the multimedia content. As mentioned above, the service provider 102 pre-processes the multimedia content and creates the index list of timing information which is subsequently transmitted to a client device. A user initiates trick modes through the client device through the index list and the index points (to be discussed in further detail with regards to FIG. 4).

In step 302, the service provider 102 receives a request from the client device which comprises at least one index point from the index list. As mentioned above, the index list comprises of index points which further comprises timing information of the multimedia content such as chapter points, time codes, and time locations of the I-B-P-frames of the multimedia content. When a user initiates trick modes, such as reverse or fast forward, at least one index point is chosen corresponding to the time within the multimedia content which the user wants to jump forward or backwards to. Once chosen, a request to navigate through the multimedia content is received by the service provider 102. In one embodiment, the request includes the index point(s) which the user has chosen.

At step 304, the service provider processes the request and transmits the portion of the multimedia content corresponding to the index point. Since the service provider 102 pre-processed the multimedia content to create the index list, the service provider already has the information as to the time location within the multimedia content corresponds to the index point and whether the client device is requesting to navigate forward or backwards through the multimedia content. Once the service provider receives the chosen index point from the client device, the service provider transmits the corresponding portion of the multimedia content to the client device. As mentioned above, the information within the index list, such as the index points, is correlated to specific time locations within the multimedia content, such as the I-B-P-frames of the multimedia content which occur at the specific time locations. Therefore a request from a client device to return multimedia content at an index point would cause the service provider to return the multimedia content at the time location of the index point. In one embodiment, what the service provider returns to the client device includes the I-B-P-frame of the multimedia content at the time location of the index point.

Referring next to FIG. 4, a flow diagram 400 of the steps taken by a client device 104-108 to utilize trick modes when viewing streamed multimedia content in accordance with one embodiment of the present invention is shown comprising the steps of receiving an index list from the service provider 402, selecting an index point from the index list 404, transmitting a request for a portion of multimedia content corresponding to the index point 406, and receiving the requested portion of multimedia content from the service provider 408.

The client device 104-108 (FIG. 1) begins to utilize trick modes by receiving the index list corresponding to streamed multimedia content in step 402. After the index list is received 402, the client device 104-108 then selects an index point from the index list at step 404. Once the index list is selected 404, the client device 104-108 transmits a request to the service provider 102 for multimedia content corresponding to the index point at step 406. Then at step 408, the client device receives the requested multimedia content from the service provider 102.

The process for utilizing trick modes for streamed multimedia content by a client device begins at step 402. Once the client device has requested specific multimedia content, such as a movie or television show, the client device receives an index list, as discussed with regards to FIGS. 2 and 3, along with streamed multimedia content. The index list comprises timing information of the multimedia content which is utilized to facilitate navigation through the streamed multimedia content on a client device which has limited local storage and buffering capabilities.

Based on the index list, the client device displays the trick mode choices to a user through a user interface. Various choices include rewind and fast forward at speeds such as ¼×, 4×, 10×, 30×, 60×, 300×, etc. It should be appreciated that the service provider 102 may determine which rewind and fast forward speeds are available to the client device. The user then selects how to navigate through the content and at what speed. Once the user determines the selection, at step 404 the client device selects at least one index point from the index list which corresponds to the user selection.

The client device then moves on to step 406 and transmits a request to the service provider for the portion of the multimedia content which corresponds to the index point. In one embodiment, the request includes at least one index point from the index list. As mentioned above with regards to FIGS. 2 and 3, the index point within the index list is correlated to specific time locations within the streamed multimedia content. The service provider then facilitates trick modes and processes the request as outlined with respect to FIG. 3. The request may occur at any time during the streaming and playback of the multimedia content. In general, the client device transmits the request to the service provider for the portion of the multimedia content prior to completion of streaming the entire multimedia content. At step 408, the client device receives the requested portion of the multimedia content from the service provider. As discussed with respect to FIG. 3, in one embodiment, the requested portion of the media content comprises at least one I-B-P-frame which is correlated to at least one index point included in the request.

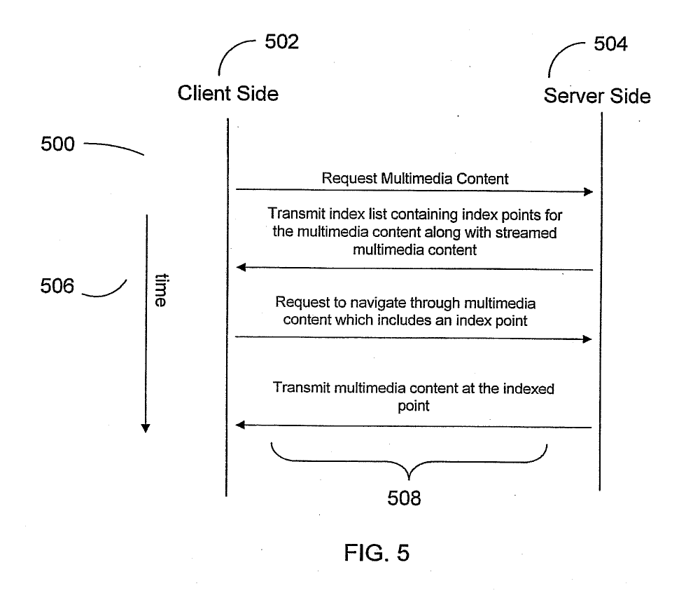

Referring next to FIG. 5, an example of a trick mode communication 500 between devices in a multimedia delivery system to facilitate trick modes in accordance with an embodiment of the present invention is illustrated comprising client side 502, server side 504, time bar 506, and conversation 508.

The client side 502 and the server side 504 exchange conversations 508 over a span of time, such as illustrated by the time bar 506. The communications between the client side 502 and the server side 504 include requests for portions of multimedia content, transmission of the index list, and navigation requests as demonstrated above. The communication between the client side 502 and the server side 504 may end when a user on the client side 502 terminates the conversation, an administrator at the server side 504 terminates the conversation, or the streamed transmission of the multimedia content has completed. It should be appreciated that these are only a few examples of what may terminate communication between the client side 502 and the server side 504.

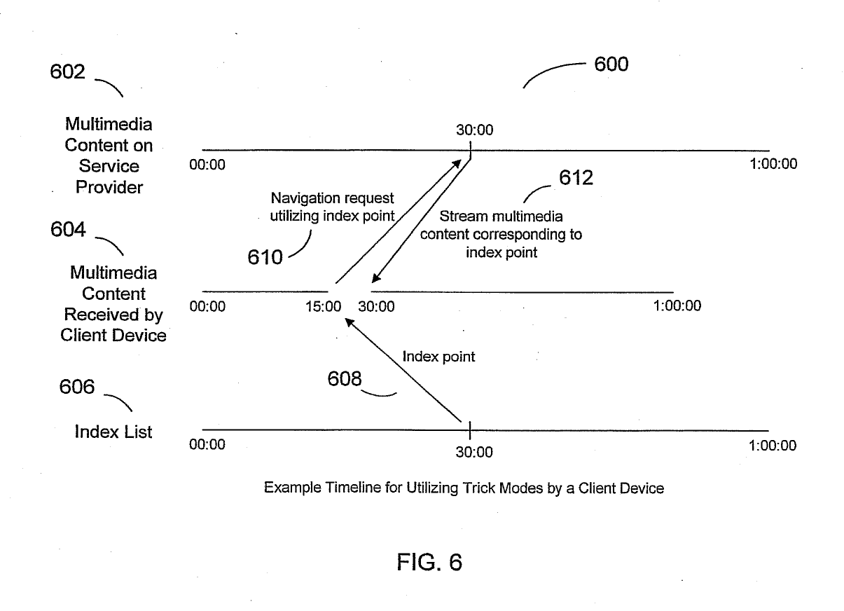

Referring next to FIG. 6, a timing diagram 600 between devices in a multimedia delivery system to facilitate trick modes in accordance with one embodiment of the present invention is illustrated comprising a server timing bar 602, client timing bar 604, index list bar 606, index point 608, client navigation request 610, and streamed content 612.

FIG. 6 illustrates an example time line of a client device utilizing trick modes. Specifically, the timing diagram 600 illustrates a client device navigating forward (roughly halfway) through the multimedia content. The timing diagram 600 includes the server timing bar 602 which represents multimedia content that may be streamed to a client device from the service provider. For the example illustrated in FIG. 6, the multimedia content on the service provider has an hour play length. However, it should be appreciated that the multimedia content may be of any play length. The client timing bar 604 represents multimedia content received by the client device from the service provider. In addition, FIG. 6 includes an index list bar 606 which exemplifies the corresponding index list of the particular multimedia content that is streamed to the client device. In the timing diagram 600, the index list bar 606 corresponds with the length of the server timing bar 602 since index points within the index list corresponds to timing information of the multimedia content. As mentioned above with reference to FIG. 2, timing information such as byte offset from the beginning of the multimedia file, time locations of I-B-P frames, or chapter points may be utilized to generate index points which are utilized to facilitate trick modes.

FIG. 6 illustrates an example of a client device utilizing the fast forward option to navigate through multimedia content. For example, at time 15:00, the client device wishes to navigate forward to portion of the multimedia content at the halfway (or 30:00 minute) point. Depending on the size and the number of frames of the multimedia content, this may be accomplished by choosing the particular speed (4×, 10×, 20×, 30×, etc.) which the user may fast forward, To utilize trick modes, and to navigate to the halfway point of the multimedia content, the client device pulls the index point 608 from the index list (exemplified as the index list bar 606) which corresponds to the halfway mark of the multimedia content. As mentioned above, the client device then sends a client navigation request 610 to navigate to the halfway point of the multimedia content streamed from the service provider. The client navigation request 610 utilizes the index point 608 pulled from the index list bar 606. In some embodiments, the client navigation request 610 includes the index point 608. Once the service provider receives the client navigation request 610, the service provider streams content 612 corresponding to the index point 608, or the particular time within the multimedia content which the client device has requested.

As illustrated in the client timing bar 604, once the client device has sent the client navigation request 610, the client device receives streamed content 612 from the point 30:00 onward. As further illustrated in the client timing bar 604, the client device resumes normal playback (1× speed) of the streamed multimedia content after the client device has navigated halfway through the multimedia content. While the timing diagram 600 illustrates a client device navigating through streamed multimedia content from the 15:00 minute mark to the 30:00 minute mark, it should be understood that the client device may navigate from any portion of the streamed multimedia content to any other portion of the streamed multimedia content at various speeds.

Referring next to FIG. 7, a structural block diagram of the client device 700 which utilizes trick modes in accordance with an embodiment of the present invention comprises communication unit 702, selection unit 704, user interface unit 706, display unit 108, and communication interface 710.

The client device 700 comprises the communication unit 702 which is coupled to the communication interface 710 and the display unit 708. The display unit 708 is further coupled to the user interface unit 706. The user interface unit 706 couples with the selection unit 704. The selection unit 704 may couple with the communication unit 702. While the communication unit 702, selection unit 704, user interface unit 706, display unit 708 and communication interface 710 are depicted as separate entities, it should be appreciated that these entities may be integrated together as one unit or any combination of units.

Information, such as multimedia content and the index list, is received by the client device 700 through the communication interface 710 and the communication unit 702. In one embodiment, the information is received through the internet, through either a wireless or a wired connection. When the connection is wireless, the communication unit 702 and communication interface 710 further comprises antenna architecture. In another embodiment, the information is received through an A/V link such as the cable connection provided by a television provider. It should be appreciated that other forms of communication may be utilized.

Information is received by the communication interface 710 and subsequently sent to the communication unit 702. The communication unit 702 comprises circuitry to receive streamed multimedia content along with the corresponding index list of the content. As mentioned above with regards to FIGS. 2, 3 and 4, the index list comprises index points and other timing information of the multimedia content and facilitates the navigation and use of trick modes through the multimedia content.

The communication unit 702 is further coupled to a display unit 708. The communication unit 702 sends signaling corresponding to the index list to the display unit 708. The display unit 708 is comprised of circuitry to display the index list as selections to a user. The selections may be options for the user, such as fast forward or reverse, at specific speeds, such as ¼×, 4×, 10×, 30×, 60×, 300× etc. The display unit 708 may be in the form of a computer monitor or a television screen; however, it should be appreciated that any form of display which converts the index list to user selections may be utilized. A user interface unit 706 is further coupled to the display unit 708. The user interface unit 706 comprises circuitry to receive user inputs corresponding to the selections on the display unit 708 which have been chosen by the user. In one embodiment, the user interface unit 706 may be a remote control interface as seen with modern televisions.

The selection unit 704 is further coupled to the communication unit 702 and the user interface unit 706 and comprises circuitry to select at least one of the corresponding index points of the index list which is associated with the user selection or input. The selected index point(s) are then forwarded to the communication unit 702, which subsequently transmit the selected index point(s) to the service provider. Together, these components execute the steps 402, 404, 406, and 408 of the flow diagram 400 of FIG. 4.

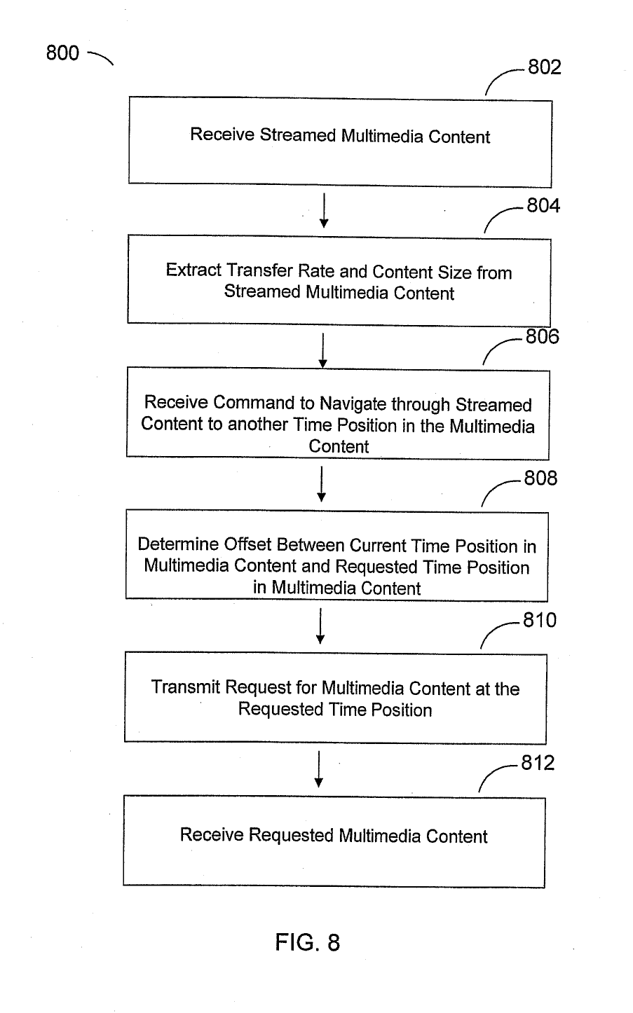

Referring next to FIG. 8, a flow diagram 800 of the steps taken by the client device to utilize trick modes when viewing and streaming multimedia content in accordance with one embodiment of the present invention comprises receiving streamed multimedia content 802, extract transfer rate and content size 804, receive command to navigate through streamed content to another time position 806, determine offset between current time position and requested time position in the multimedia content 808, transmit a request for multimedia content at the requested time position 810, receive requested multimedia content 812.

The process to utilize trick modes by the client device begins at step 802, when the client device receives streamed multimedia content. At step 804, the client device extracts the transfer rate and content size from the streamed multimedia content of step 802. When a user decides to implement trick modes such as fast forward or rewind at various speeds, the client device receives a command to navigate through streamed content to another time position in the multimedia content at step 806. Once the command is received 806, the client device determines the offset between the current time position in the multimedia content and the requested time position in step 808. The determined offset is then utilized in transmitting a request for multimedia content at the requested time position at step 810. After the request has been transmitted 810, the client device receives the requested multimedia content at step 812.

In accordance with another embodiment of the present invention, the client device facilitates trick modes and navigation through streamed multimedia content by estimating the offset between a current time position and a requested time position. This embodiment could be utilized when neither the client device nor the service provider knows at what time location the I-B-P-frames of the multimedia content reside. The following embodiment allows the client device and service provider to utilize trick modes without the need for hefty pre-processing at the service provider. At step 802, the client device receives streamed multimedia content from the service provider. As mentioned above, the multimedia content may be received through the internet, cable connection, or other means.

At step 804, the client device extracts the transfer rate of the streamed multimedia content and the content size of the multimedia content from the multimedia content itself In one embodiment, the transfer rate corresponds to the playrate or the bitrate which the multimedia content is encoded to play at. The client device already knows the transfer rate of the streamed content, since the transfer rate is a field inside the picture header of the multimedia file. The content size of the multimedia content may be found in the directory of the multimedia file, since the total length of the media file is passed down from service provider to the client device.

Once the client device has extracted the transfer rate and content size of the multimedia content, the client device may then present options to the user. In one embodiment, the client device is prompted by the user to present the available trick mode or navigation options. Available navigation options may include forward or rewind at various speeds such as ¼×, 4×, 10×, 30×, 60×, and 300×. However, it should be appreciated that there are many available navigation options at various speeds other than what is listed. The user reviews the available navigation options then determines which trick mode is enabled and at what speed.

At step 806, the client device then receives the user command to navigate through the multimedia content to another time position. In one embodiment, the command is received through a user interface device such as a remote control. The command is correlated to the user selection previously presented by the client device. In one embodiment, the command may include the specific trick mode (such as fast forward, reverse, and pause) and the playback speed.

Once the client device has received the command, the client device extracts the relevant information to facilitate trick modes, such as the speed the user wants to navigate through the multimedia content and the corresponding requested time position. At step 808, the client device determines the offset between the current time position in the multimedia content and the requested time position in the multimedia content. The offset is utilized to facilitate trick modes without requiring the client device to have large buffering capabilities and avoids preprocessing at the service provider. The offset is calculated based on the transfer rate, content size, and the user command and represents the time difference between the current time position within the multimedia content and the time position of the portion of multimedia content which the user has selected to “jump” to. The client device may estimate roughly the number of bytes between I-B-P-frames of the multimedia content. Using the content size, the client device then knows roughly the total number of frames within the multimedia content. When implementing trick modes, the user selects what portion of multimedia content he/she wishes to navigate to. The offset is then estimated between the current time position of the multimedia content and the time position which the user has chosen utilizing the estimated number of frames determined between the two time locations and the estimated number of bytes between each frame. In addition, the offset is indicated in bytes and the offset may also be calculated from the average bitrate (in bytes per second) multiplied by the time offset between the current position of the multimedia content and time position which the user has indicated. It should be appreciated that other methods may be utilized in determining the offset between a current time position and the navigated time position. In one embodiment, once the offset between a current time position and a requested time position is estimated, the estimated offset may then be exemplified as the byte offset from the beginning of the multimedia file. For example. The offset between two time locations may be calculated as 12 kbytes, but the multimedia file began 20 kbytes previous, then the total offset to the requested time position would be 32 kbytes. In one embodiment, the time location which the user requests to navigate between corresponds to time locations of the I-B-P-frames of the multimedia content.

For example, the client device is receiving multimedia content and the user has indicated to fast forward at 3× speed (return every third I-B-P-frame of the multimedia content, or in another embodiment, return every third I-frame with empty B-frame stuffing instead of I-P-B-frames). The client device then estimates the most likely location for the next I-B-P-frame which is at the speed 3× away, or for this example, the third I-B-P-frame away. The offset to this I-B-P-frame is then determined by utilizing the number of frames/sec, transfer rate (bytes/sec), and the specific I-B-P-frame which the user wishes to navigate through. The client device then calculates the number of bytes needed to jump ahead every third I-B-P-frame. The client device does not know exactly the number of bytes ahead every third I-B-P-frame is, however, by estimating the number of bytes between each frame, the client device estimates the offset (in number of bytes) between the current time position of the I-B-P-frame and the requested time position of the requested I-B-P-frame. Depending on the content size and the average number of frames per second, the client device may also estimate the total number of frames within the multimedia content. In general, the number of frames per second is fixed for most multimedia content, however there are rare cases in which the multimedia content has variable frame rate. In one embodiment, the total number of frames may be calculated by multiplying the total play time of the multimedia content by the frame rate (such as 15 fps, 25 fps, 30 fps, etc.). The client device would have an estimate of the approximate number of frames that would need to be traversed for every speed which could be chosen by the user. For example, the client device estimates 6,000 bytes between each I-B-P-frame and the third I-B-P-frame forward was estimated to be roughly be an offset of 18 kbytes (assuming 100 I-B-P-frames within the multimedia content, however, this number alters depending on the total length of the multimedia content). The determined offset is then sent to the service provider to facilitate trick modes.

At step 810, the client device transmits a request for the multimedia content at the requested time position. The request includes the determined offset of step 808. The service provider then extracts the offset from the client request and transmits the next I-B-P-frame after the offset provided by the client device. For the example above, the client device has estimated that the next I-B-P-frame, when wishing to fast forward at 3× speed, is at an offset 8 kbytes away. However, in actuality the nearest succeeding I-B-P-frame may be 19 kbytes away. Therefore, the service provider sends the I-B-P-frame at an offset of 19 kbytes, since this is the succeeding I-B-P-frame to the requested time position. In another embodiment, the service provider may transmit the I-B-P-frame within the multimedia content which lies closest to the requested offset, regardless of succession. In general, the request is transmitted before the entire multimedia content is received since the methods above may be applied to client devices with little buffering capabilities.

In step 812, the client device receives the multimedia content at the requested offset and subsequently displays the multimedia content to the user. In essence, the client device receives the requested I-B-P-frame of the multimedia content and displays the I-B-P-frame to the user. As mentioned above, previous methods for enabling trick modes for streamed multimedia content required the download of the entire multimedia content prior to a user viewing the multimedia content on a client device or the client devices would need to download additional files which consisted of the multimedia content in reverse and fast forward format, such as files comprising of every 4^{th} I-B-P-frame of the multimedia content. This method required large local storage and buffering capabilities on the part of the client device along with extensive pre-processing on the part of the server would also be required to create the additional files. By determining the offset between requested I-B-P-frames, the embodiment of the present invention removes the need for excess processing by the part of the service provider. In addition, determining the offset could be utilized when neither the client device nor the service provider knows at which time location the I-B-P-frames of the multimedia content reside. The intelligence is found on the client device.

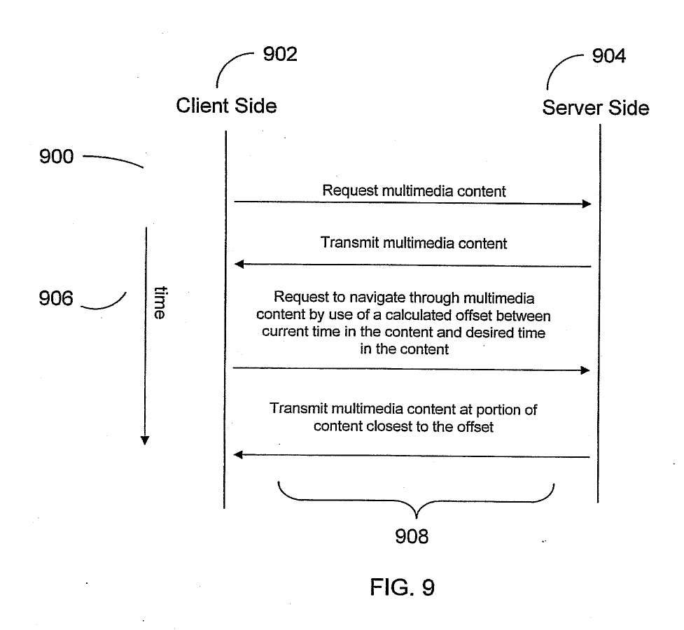

Referring next to FIG. 9, an example of another trick mode communication 900 between devices in a multimedia delivery system to facilitate trick modes as presented in regards to FIG. 8 is illustrated comprising client side 902, server side 904, time bar 906, and conversation 908.

The client side 902 and the server side 904 exchange conversations 908 over a span of time, such as illustrated by the time bar 906. The communications between the client side 902 and the server side 904 include requests for portions of multimedia content, portions of multimedia content, and navigation requests as demonstrated above with regards to FIG. 8 which include a determined offset calculated on the client side 902. The communication between the client side 902 and the server side 904 may end when a user on the client side 902 terminates the conversation, an administrator at the server side 904 terminates the conversation, or the streamed transmission of the multimedia content has completed. It should be appreciated that these are only a few examples of what may terminate communication between the client side 902 and the server side 904.

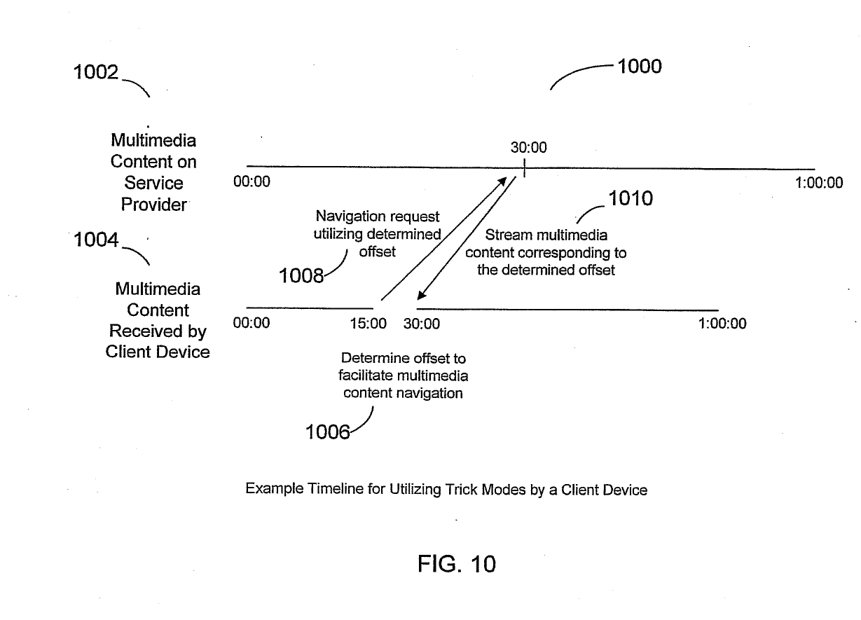

Referring next to FIG. 10, a timing diagram 1000 between devices in a multimedia delivery system to facilitate trick modes in accordance with an embodiment of the present invention is shown comprising a server timing bar 1002, client timing bar 1004, offset determination 1006, client navigation request 1008, and streamed content 1010.

Similar to FIG. 6, FIG. 10 illustrates an example time line of a client device utilizing trick modes, fast forward in particular, to navigate forward to the halfway portion of the multimedia content. The timing diagram 1000 includes the server timing bar 1002 which represents multimedia content that may be streamed to a client device from the service provider. For the example illustrated in FIG. 10, the multimedia content has an hour play length. A client timing bar 1004 is also included in the timing diagram 1000. The client timing bar 1004 exemplifies multimedia content received by the client device from the service provider. The received multimedia content is then displayed to a user.

FIG. 10 illustrates an example of a client device utilizing fast forward to navigate through the multimedia content. For example, at time 15:00, the client device has received instructions from a user to navigate forward to a portion of the multimedia content at the halfway, or 30:00 minute, point. Depending on the size and the number of frames in the multimedia content, this may be accomplished by choosing the particular speed (4×, 10 ×, 20×, etc.) which the user may fast forward. As previously discussed in detail with respect to FIG. 8, the client device performs offset determination 1006 to determine the offset between the current time position in the multimedia content and the requested time position in the multimedia content. For the timing diagram 1000, the current time position is at 15:00 minutes while the requested time position is at 30:00 minutes. The client device then sends client navigation request 1008 which includes the determined offset calculated from the offset determination 1006. Once the service provider receives the client navigation request 1008, the service provider then streams content 1010 which correspond to the offset extracted from the client navigation request 1008. As mentioned above, since the offset is estimated, the service provider streams the next I-P-B frame after the offset provided by the client device.

For the time line example of FIG. 10, as illustrated by the client timing bar 1004, once the client device has sent the client navigation request 1008, the client device receives the next streamed content 1010 from the offset determination 1006 at the point 30:00 onward. The client timing bar 1004 then receives streamed content 1010 from the time location 30:00 until the end of the multimedia content at time location 1:00:00. As depicted by the client timing bar 1004, the client device resumes normal playback (1× speed) of the streamed multimedia content after the client device has navigated halfway through the multimedia content. While the timing diagram 1000 illustrates a client device navigating through streamed multimedia content of an hour length from the 15:00 minute mark to the 30:00 minute mark, it should be understood that the multimedia content may be of any play length and the client deice may navigate from any portion of the streamed multimedia content to any other portion of the streamed multimedia content at various speeds.

Referring next to FIG. 11, a structural block diagram of the client device 1100 which utilizes trick modes in accordance with another embodiment of the present invention, as presented with regards to FIG. 8, comprising of communication unit 1102, determination unit 1104, user interface unit 1106, display unit 1108, and communication interface unit 1110.

The client device 1100 comprises the communication unit 1102 which is coupled to the communication interface 1110 and the display unit 1108. The display unit 1108 is further coupled to the user interface unit 1106. The user interface unit 1106 couples with the determination unit 1104. The determination unit 1104 may couple with the communication unit 1102. While the communication unit 1102, determination unit 1104, user interface unit 1106, display unit 1108 and communication interface 1110 are depicted as separate entities, it should be appreciated that these entities may be integrated together as one unit or any combination of units.

Signaling and information corresponding to multimedia content is received by the client device 1100 through the communication interface 1110 and the communication unit 1102. The received multimedia content also includes information such as the transfer rate and content size of the multimedia content. When the multimedia content is A/V content such as a movie, the transfer rate may be found in the picture header and the content size is a part of the directory of the media file. The multimedia content is also comprised of a plurality of I-B-P-frames. The client device facilitates navigation through the multimedia content by determining the number of bytes between I-B-P-frames and further determining the offset between requested I-B-P-frames, as described above in regards to FIG. 8. In one embodiment, the multimedia content is received through the internet by either a wired or a wireless connection. When the connection is wireless, the communication unit 1102 and communication interface unit 1110 further comprises antenna circuitry. In another embodiment, the multimedia content is received through a cable connection provided by a television provider. The multimedia content and corresponding information is received by the communication interface 1110 and subsequently sent to the communication unit 1102. The communication unit 1102 comprises circuitry to receive streamed multimedia content and the subsequent I-B-P-frames.

The communication unit 1102 is further coupled to the display unit 1108. The display unit 1108 comprises circuitry to display the multimedia content to a user. The display unit 1108 may also display trick mode selections to a user. These trick mode selections may include functions such as pause, rewind, and fast forward. In addition, the display unit 1108 may also display at what speeds these functions may be performed. Such as fast forward or rewind at 3×, 9×, 10×, and 30×. It may be appreciated that there are many other trick mode functions which may be performed at other speeds than what is disclosed above. The display unit 1108 may be in the form of a computer monitor or television screen; however any form of display which may receive streamed multimedia content and display the multimedia content along with trick mode functions may be utilized.

The user interface unit 1106 is coupled to the display unit 1108 and comprises of circuitry to receive commands for navigating to different portions of the multimedia content from a user. The commands correspond to the selections made by the user with regards to the available trick modes of the client device. In some embodiments, the user interface unit 1106 is a remote control interface as seen with modern television systems. In further embodiments, the user interface unit 1106 is a mouse and keyboard of a computer.

The user interface unit is further coupled to the determination unit 1104. The determination unit 1104 comprises of circuitry to determine the offset corresponding to the user command to navigate through the multimedia content. As mentioned with regards to FIG. 8, the offset is the time difference (and the byte difference) between the current time position of the multimedia content and the requested time position of the requested multimedia content. To facilitate trick modes, the client device 1100 determines the offset between the current I-frame and the desired I-frame, where the desired I-frame meets the navigation commands of the user (such as every third I-frame for fast forwarding at 3× speed). The offset is calculated from the transfer rate, content size, average number of frames per second, and the chosen trick mode function of the user. For example, if the determination unit 1104 has estimated that there are 6000 bytes between each I-frame and has further determined that the I-frame to facilitate 3× fast forwarding is the third I-frame forward, then the determined offset is roughly 18 kbytes. It should be appreciated that the exact number of bytes between each I-frame is difficult to determine since each frame is a function of scene complexity and relationship to the previous frames. However, in one embodiment, the number of bytes between frames may be estimated utilizing the delta function in time as a fraction of total time translated to file size. Once the offset is calculated, the determination unit 1104 sends signaling corresponding to the offset to the communication unit 1102.

The communication unit 1102 and the communication interface 1110 are further configured to transmit a request for portions of the multimedia content along with the determined offset. In return, the communication unit 1102 and the communication interface 1110 are configured to receive the portions of multimedia content corresponding to the request, along with the subsequent I-frames. As mentioned above, the offset calculated by the client device 1100 is an estimate of the most likely time when an I-frame which meets the chosen user trick mode command occurs. As with the example above, the determination unit 1104 may have found the offset to be 18 kbytes, but in reality the subsequent offset is at 19 bytes. Therefore, the communication unit 1102 receives the I-frame found at the 19 kbyte offset, since this is the succeeding I-frame to the requested time position. In another embodiment, the communication unit 1102 may receive the I-frame within the multimedia content which lies closest to the requested offset, regardless of succession. Together, the communication unit 1102, determination unit 1104, user interface unit 1106, display unit 1108, and communication interface unit 1110 execute the steps 802-812 to facilitate trick modes for streamed multimedia content.

While the invention herein disclosed has been described by means of specific embodiments, examples and applications thereof, numerous modifications and variations could be made thereto by those skilled in the art without departing from the scope of the invention set forth in the claims.

What is claimed is:

1. A method for streaming multimedia content comprising:
pre-processing multimedia content, wherein the multimedia content comprises a plurality of frames;
creating an index list from the pre-processed multimedia content comprising a plurality of index points corresponding to timing information of portions of the multimedia content, wherein the index list facilitates navigation through the multimedia content; and
transmitting the index list to a client device configured to view the multimedia content.

2. The method of claim 1 further comprising:
receiving a request for one of the portions of multimedia content, wherein the request comprises one of the plurality of index points; and
transmitting one of the portions of multimedia content corresponding to the request to the client device.

3. The method of claim 2, wherein transmitting one of the portions of multimedia content corresponding to the request further comprises transmitting one of the portions of multimedia content corresponding to the request to the client device, wherein one of the portions of multimedia content comprises at least one of the plurality of frames.

4. The method of claim 1, wherein creating the index list comprising the plurality of index points corresponding to timing information of the portions of the multimedia content and further comprising time codes associated with the portions of the multimedia content.

5. The method of claim 1, further comprising creating the index list from the pre-processed multimedia content comprising the plurality of index points corresponding to timing information of the portions of the multimedia content, the portions of multimedia content comprising at least one of the plurality of frames.

6. A method for navigating multimedia content comprising:
receiving an index list comprising a plurality of index points corresponding to timing information of portions of multimedia content, wherein the index list facilitates navigation through the multimedia content;
selecting one of the plurality of index points from the index list;
transmitting a request, after selecting one of the plurality of index points, to a service provider for one of the portions of multimedia content, wherein the request comprises the corresponding one of the plurality of index points; and
receiving one of the portions of multimedia content corresponding to the request.

7. The method of claim 6, further comprising, before selecting one of the plurality of index points from the index list:
displaying selections corresponding to the plurality of index points.

8. The method of claim 6, further comprising transmitting a the request for one of the portions of multimedia content prior to receiving all the portions of multimedia content.

9. The method of claim 6, further comprising receiving the index list comprising the plurality of index points corresponding to timing information of the portions of multimedia content and further comprising time codes associated with the portions of multimedia content.

10. The method of claim 6, wherein receiving one of the portions of multimedia content corresponding to the request further comprises receiving one of the portions of multimedia content corresponding to the request, wherein one of the portions of multimedia content comprises at least one frame.

11. A method for navigating content comprising:
receiving multimedia content and a corresponding transfer rate and content size of the multimedia content, wherein the multimedia content comprises a plurality of frames;
receiving a command to navigate to a portion of the multimedia content;
determining an offset associated with the command, wherein the offset corresponds to the time difference between a current time position of the multimedia content and a time position of the portion of the multimedia content determined by at least one of the transfer rate, content size, and the portion of the multimedia content;
transmitting a request for the portion of the multimedia content, wherein the request comprises the offset; and
receiving the portion of the multimedia content.

12. The method of claim 11, wherein receiving the portion of the multimedia content further comprises receiving the portion of the multimedia content, wherein the portion of multimedia content comprises at least one of the plurality of frames.

13. The method of claim 11, wherein receiving the portion of the multimedia content further comprises receiving the next one of the plurality of frames after the time position of the portion of the multimedia content.

14. The method of claim 11, further comprising transmitting the request for the portion of the multimedia content prior to receiving the entire multimedia content.

15. A device for navigating content, comprising:
a communication unit configured to receive multimedia content and an index list comprising a plurality of index points corresponding to timing information of portions of the multimedia content, wherein the index list facilitates navigation through the multimedia content;
a display unit coupled to the communication unit configured to display selections corresponding to the plurality of index points and the multimedia content;
a user interface unit coupled to the display unit configured to receive user inputs corresponding to the selections; and
a selection unit coupled to the user interface unit configured to select one of the plurality of index points associated with the user inputs.

16. The device of claim 15, wherein the communication unit is further configured to transmit a request for one of the portions of the multimedia content and receive one of the portions of the multimedia content corresponding to the request, wherein the portions of the multimedia content comprises at least one frame.

17. The device of claim 15, wherein the communication unit is further configured to receive the index list comprising the plurality of index points corresponding to timing information of the portions of the multimedia content and the time codes associated with the portions of the multimedia content.

18. A device for navigating content, comprising:
a communication unit configured to receive multimedia content and corresponding transfer rate and content size of the multimedia content, wherein the multimedia content comprises a plurality of frames;
a display unit coupled to the communication unit configured to display the multimedia content;
a user interface unit coupled to the display unit configured to receive commands associated with navigating to a portion of the multimedia content; and
a determination unit coupled to the user interface unit configured to determine an offset associated with the commands, wherein the offset corresponds to the time difference between a current time position of the multimedia content and a time position of the portion of the multimedia content determined by at least one of the transfer rate, content size, and the portion of the multimedia content.

19. The device of claim 18, wherein the communication unit is further configured to transmit a request for the portion of the multimedia content and receive the portion of the multimedia content.

20. The device of claim 19, wherein the communication unit is further configured to receive the portion of the multimedia content, wherein the portion of the multimedia content comprises at least one of the plurality of frames.

21. The device of claim 19, wherein the communication unit is further configured to receive the next one of the plurality of frames after the time position of the portion of the multimedia content.
